(19) United States
(12) Patent Application Publication
(10) Pub. No.: US 2015/0236704 A1
(43) Pub. Date: Aug. 20, 2015

(54) METHOD FOR OPTIMIZING THE EFFICIENCY OF A SYSTEM OF PARALLEL-CONNECTED GENERATORS

(71) Applicant: Remy Technologies, LLC, Pendleton, IN (US)

(72) Inventor: Timothy J. Alfermann, Carmel, IN (US)

(21) Appl. No.: 14/626,811

(22) Filed: Feb. 19, 2015

Related U.S. Application Data
(60) Provisional application No. 61/941,863, filed on Feb. 19, 2014.

(51) Int. Cl. H03L 5/02; G05B 15/02

(52) U.S. Cl. CPC H03L 5/02; G05B 15/02

(57) ABSTRACT

A parallel generator system having a plurality of parallel-connected generator units and a controller for selective activation and deactivation of generator units, wherein generator units are selectively activated and deactivated by the controller based on system efficiency level and the number of active generator units, and a method for using a controller to selectively activate and deactivate generator units based on system efficiency level and the number of generator units, in a parallel generator system.

### PRIORITY CLAIM AND CROSS-REFERENCE TO RELATED APPLICATIONS

This application claims the benefit under Title 35, U.S.C. §119(e) of U.S. Provisional Patent Application Ser. No. 61/941,863 filed Feb. 19, 2014 entitled METHOD FOR OPTIMIZING THE EFFICIENCY OF A SYSTEM OF PARALLEL-CONNECTED GENERATORS; and is related to U.S. patent application Ser. No. ______ entitled METHOD FOR LOAD SHARE BALANCING IN A SYSTEM OF PARALLEL-CONNECTED GENERATORS USING ACCUMULATED DAMAGE MODEL filed on Feb. 19, 2015 (Attorney Docket No. 22888-0206), and U.S. patent application Ser. No. ______ entitled METHOD FOR LOAD SHARE BALANCING IN A SYSTEM OF PARALLEL-CONNECTED GENERATORS USING SELECTIVE LOAD REDUCTION filed on Feb. 19, 2015 (Attorney Docket No. 22888-0208), the entire disclosures of which are incorporated herein by reference.

### BACKGROUND

The present disclosure generally relates to systems and methods for generating and distributing electrical power, and more particularly such systems and methods which involve multiple electrical generators connected in parallel.

Typically, a generator is a rotary electric machine of well-known type having a stator surrounded by a rotor that is driven through a belt or shaft by a prime mover (e.g., an engine) to electromagnetically induce electrical current in conductive windings of the stator, whereby mechanical power is converted into electrical power. A generator may be a DC type that produces direct current or an AC type that produces an alternating current, the latter type also referred to as an alternator. Where used to charge a battery that powers an electrical system, alternator output is rectified. A parallel system of DC generators may include an invertor to convert DC generator output to AC system output power as necessary. Reference herein to a “generator” may refer to either type (i.e., DC or AC), unless an alternator is specified.

Parallel generator systems, wherein multiple generators one type (i.e., DC or AC) are electrically connected to each other in parallel, may be adapted for use in stationary installations, usually to provide backup power for a building or campus, or in mobile installations, and may be a primary power source for charging batteries that provide electrical power for various types of vehicles, such as over-the-road tractors or large buses, for example.

Parallel generator systems are well-known for ensuring an uninterrupted supply of power and have significant advantages over single large generator units in areas of cost effectiveness, flexibility, expandability, ease of maintenance and serviceability, and reliability.

The individual generator units operating in parallel systems are typically of smaller capacities, and may be identical or of variable output. In either case, these units can be connected in parallel with paralleling switchgear to achieve maximum output during peak requirement or the desired minimal output during other times. Often, each generator has its own digital microcontroller (referred to herein as a generator controller) which may be a plug and play device. Each of the generator controllers controls the operation of its respective individual generator unit, and cooperates in the operation of the overall parallel system, which may be controlled by an optionally included master controller. The generators may coordinate among themselves or, optionally, may designate a system master controller that is either internal to one generator or an external electronic control unit.

Using multiple generator units in parallel offers greater flexibility than using a single large-sized generator of a high capacity. Multiple smaller generators operating in parallel do not need to be grouped together and can be distributed such that they are remotely located from each other and do not require a single, large space, as would be needed in the case of a single, larger generator. Furthermore, it is often difficult when sizing generators to match load requirements to accurately project increases in load and adequately plan for anticipated additional loads; by operating generators in parallel, variations in load can be relatively easy to accommodate by adding additional parallel-connected generators for additional power supply provided. Thus, by operating generators in a parallel system, it is easier to allow for an increase in the load requirement. Moreover, if a generator unit in the parallel system breaks down or requires maintenance, that individual unit can be removed from service, and repaired or replaced, without disrupting the functioning of the other generator units in the system.

As those of ordinary skill in the art appreciate, to avoid damage the introduction (or reintroduction) of an incoming alternator to active service within a parallel generator system requires its synchronization, as closely as possible, with the other, operating alternators of the system, before they are interconnected through a common bus. Synchronization of an incoming alternator may be accomplished by connecting one operating alternator of the system to the bus (referred to as the bus alternator), and then synchronizing the incoming alternator to the bus alternator before closing the incoming alternator's main power contactor. Typically, the alternators are synchronized when: they have equal terminal voltages (setpoints), which may be achieved through adjustment of the incoming alternator's field strength; they are of equal frequency, which may be achieved through adjustment of the incoming alternator's rotational speed (though usually not called for in vehicle-based system where identical alternators are driven by the engine crankshaft through a common belt); and their phase voltages are in proper relation. Automatic synchronizing equipment is also known to those of ordinary skill in the art and can be utilized in many situations for bringing an alternator into active service in a parallel system. The above synchronization functions are typically regulated by the generator controllers and/or the optional master controller. The synchronization of DC type generators is relatively simpler, as it may be limited to equalizing their voltage setpoints.

The redundancy inherent in parallel operation of multiple generators provides greater reliability than is offered by a single generator unit for critical loads. If one unit fails, the critical loads are redistributed among other units in the system, typically on a priority basis. In many applications, critical loads needing the highest degree of reliable power account for only a fraction of the overall power generated by the system, and parallel systems provide the redundancy necessary to maintain power to critical loads even if one of its generator units fails. The redundancy inherent in a parallel system thus provides multiple layers of protection and ensures an uninterrupted supply of power for critical circuits.

Some parallel generator systems employ a plurality of prime movers to drive the multiplicity of generators. For example, an engine may be dedicated to driving only a respective one of the multiplicity of parallel-connected generators, as is typical in large stationary backup power systems.

Other parallel generator systems, particularly those used in vehicles, employ a single engine to drive the multiplicity of generators. For example, the single engine of an over-the-road tractor or large bus drives each of the multiplicity of parallel-connected generators, which are typically alternators mounted to the engine and driven by the crankshaft through a common belt. Often, these generator units are substantially identical to each other and, regardless of whether activated, are all driven at a common speed that varies directly with engine speed. Such vehicle-based systems of parallel-connected alternators typically provide rectified DC power to a battery (or multiple batteries) that provides power to the vehicle's electrical system. The multiple alternators may be identical to each other, and may be driven at a common speed that is a ratio of the engine crankshaft speed. The output of the stator windings of each alternator providing power to the generator system (i.e., each active generator) is normally controlled by a single voltage regulator common to all alternators in the system, or a single, dedicated voltage regulator for that respective alternator. The strength of each rotor's moving magnetic field, which induces current flow in the stator windings of the surrounding stator to generate alternator output voltage, is controlled by the voltage regulator(s).

In a parallel generator system, the entire load is shared by all of the parallel-connected generators operating in the system, i.e., the active generators. In prior systems, load sharing is typically done to ensure all generators contribute the same power toward the load. This approach, however, ignores system efficiencies that may otherwise result.

Activating and deactivating the generator units in a coordinated manner that better adapts them to a particular load demand and operating condition would improve system efficiency for a given operating point.

### SUMMARY

The present disclosure provides a parallel generator system, including a system bus adapted for connection to an electrical load, a plurality of generator units connectable in parallel to the system bus, and a plurality of controllers for selective activation and deactivation of at least one generator unit. Each generator unit is activated when providing electrical power to the system bus. At least one generator unit is selectively activated and deactivated by the controller based on system efficiency level and the number of active generator units, whereby the efficiency of the system subsequent to the selective activation or deactivation of at least one generator unit is increased.

The present disclosure also provides a method for using a controller to selectively activate and deactivate generator units based on system efficiency level and the number of generator units, in a parallel generator system.

The objective of the system and method disclosed herein is to maximize the efficiency of a system of parallel-connected generators all operating at the same shaft speed. The method activates and deactivates the generators so that the active generators operate in the most efficient area of operation. If the active generators are operating in one inefficient region, one or more of these generator units are deactivated to push the operation of the remaining active generator(s) into a more efficient region. If one or more active generators are operating in another inefficient region, additional generator units are activated to push the operation of all generators that are now active, into a more efficient region.

In accordance with the teachings of the present disclosure, more efficient utilization of the generator units of a parallel generator system is facilitated, thereby improving system efficiency vis-à-vis prior parallel generator systems.

### BRIEF DESCRIPTION OF THE DRAWINGS

The above-mentioned aspects and other characteristics and advantages of a system and/or method according to the present disclosure will become more apparent and will be better understood by reference to the following description of exemplary embodiments taken in conjunction with the accompanying drawings, wherein:

FIG. 1 depicts a schematic of an example parallel generator system embodiment according to the present disclosure;

FIG. 2 shows a graph of generator output vs. rotational speed, indicating operating regions of varying generator efficiency;

FIG. 3 shows the graph of FIG. 2 with shaded first (upper) and second (lower) operating regions in which the efficiency of active generator operation is less than optimal, and an operating region of relatively greater efficiency in which the parallel generator system can be operated, at the same speed, through selective activation or deactivation of the system's generators according to the method herein disclosed;

FIG. 4 shows a graph similar to that of FIG. 3, indicating parallel generator system efficiency improvements that can be obtained under a first set of load demand and generator speed conditions by increasing the number of active generator units with a method according to the present disclosure;

FIG. 5 shows a graph similar to that of FIG. 3, indicating parallel generator system efficiency improvements that can be obtained under a second set of load demand and generator speed conditions by decreasing the number of active generator units with a method according to the present disclosure;

FIG. 6 shows a graph similar to that of FIG. 3, indicating parallel generator system efficiency improvements that can be obtained under a third set of load demand and generator speed conditions by decreasing the number of active generator units with a method according to the present disclosure; and

FIG. 7 shows an example of an algorithm for use in selectively increasing and decreasing the number of active generators of a parallel generator system by a method embodiment according to the present disclosure.

### DETAILED DESCRIPTION OF EXEMPLARY EMBODIMENT(S)

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

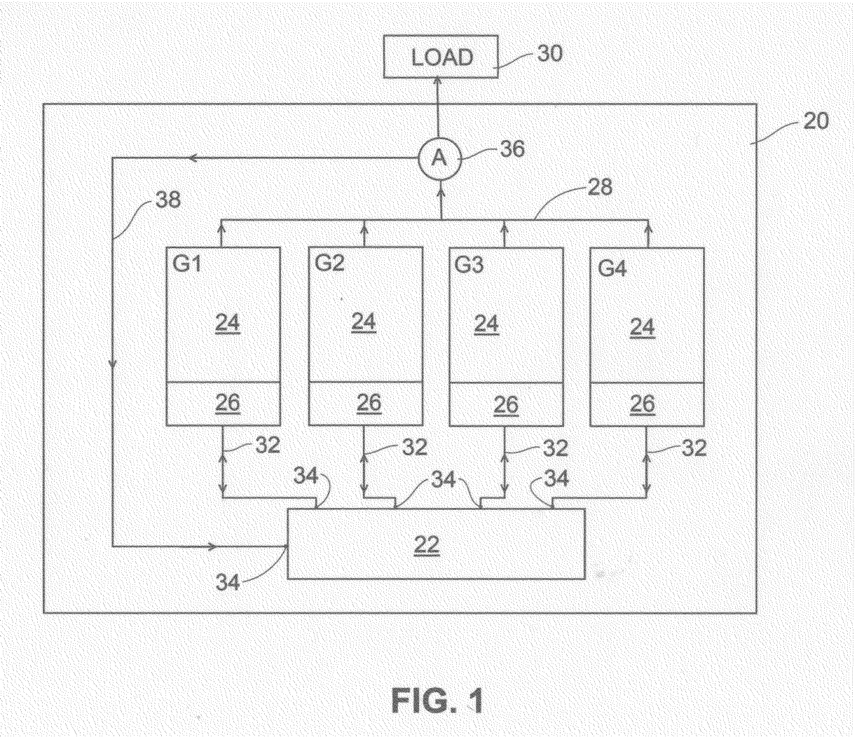

FIG. 1 schematically shows an example parallel generator system embodiment connected to an electrical load. As depicted, system 20 includes master controller 22, and four parallel-connected generator units 24, respectively designated G1, G2, G3, and G4, each with its own generator controller 26. As discussed further below, the inclusion of master controller 22 is optional; the generator controller(s) 26 of one generator unit 24, or of the multiplicity of generator units 24, may be adapted to carry out the method of load share balancing disclosed herein. The generator units 24 are commonly driven by a single prime mover at varying speeds.

In the depicted embodiment, the optionally-included master controller 22 is separate and located remotely from each of generator units 24. Alternatively, in some embodiments the master controller 22 and the generator controller 26 of one of the generator units 24 (which may then be considered the master generator unit) can be integrated into a combined master/generator controller. As a further alternative, in some embodiments the intercommunicating generator controllers 26 of the multiplicity of generator units 24 included in system 20 can cooperatively perform the herein-disclosed method and decide between themselves which of the generator units 24 shall be affected (i.e., selectively activated or deactivated, or whose electrical load is partially transferred) according to the disclosed method. In such embodiments, the need for a separate master controller 22 and its attendant cost and packaging considerations may therefore be avoided.

The generator units 24 are each electrically connected to a system bus 28 when introduced into active service in the system 20. By becoming connected to the system bus 28, or having its field energized by its voltage regulator in the case of an alternator, a driven generator unit 24 becomes active; active generator units 24 are parallel-connected to each other through the bus 28, and power generated by each generator unit 24 is transferred to the system load 30 through the bus 28.

In the depicted embodiment, regardless of whether active or inactive, each of the generator controllers 26 is individually in serial communication with the master controller 22 through a respective serial communication cable 32. From the perspective of a generator controller 26, and as is typical of serial communication concepts, each serial communication cable 32 has, in addition to its ground line, a transmit line over which data is communicated from the generator controller 26 to the system master controller 22, and a receive line over which data is communicated from the system master controller 22 to the generator controller 26. Each generator controller 26 is connected through its respective cable 32 to its respectively associated serial port 34 of the master controller 22. Alternatively, in some embodiments the communication cables 32 could be daisy-chained, such as those in which master controller 22 is omitted as discussed above.

An ammeter 36 may be provided between the system bus 28 and the system load 30, whereby the electric current provided by the system 20 to the load 30 is measured and provided, in the depicted embodiment, as an input to the master controller 22 for determining the magnitude of the load 30. Such an ammeter 36 may also be in serial communication with the master controller 22 via a serial communication cable 38. Alternatively, in some embodiments, the portion of load 30 borne by each active generator unit 24 can be measured by its generator controller 26, and these load portions summed up. For example, in some embodiments where the generator units are alternators, current can be determined from the duty cycle on all active alternator voltage regulators. Thus current, and thus the load 30, can be determined through measurement internal to the active generator unit(s) 24.

In the exemplary, non-limiting embodiment discussed below, the generator units 24 of the parallel generator system 20 are AC-type, i.e., alternators, that are substantially identical and are driven at a common, varying speed regardless of whether activated. Such an embodiment may, for example, be adapted for use in a large, over-the-road tractor or bus for charging a 24-volt battery that powers the vehicle electrical system.

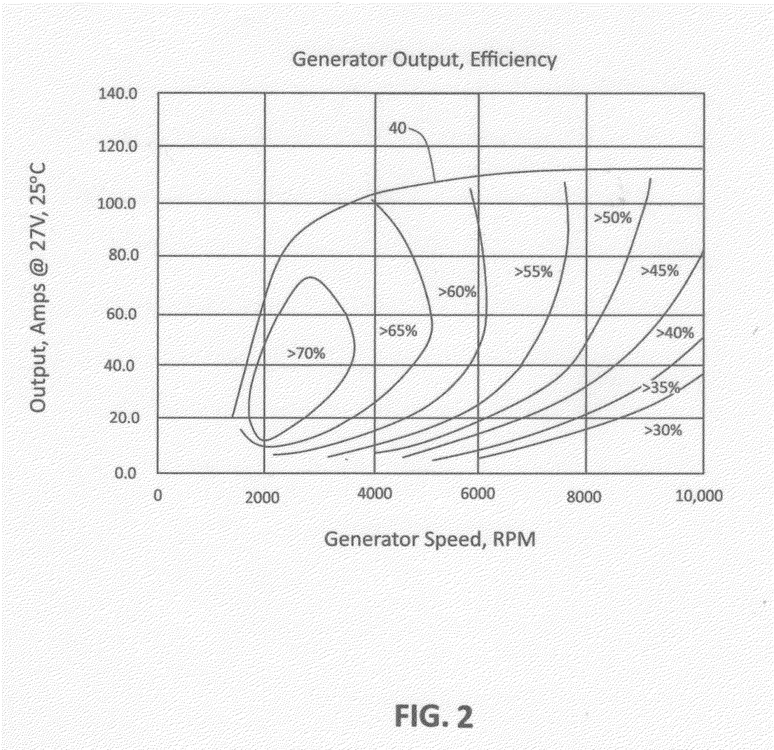

FIG. 2 shows an output and efficiency graph for a generator unit 24. Under curve 40 are identified ranges of different operation efficiencies, ranging from >70% to >30%.

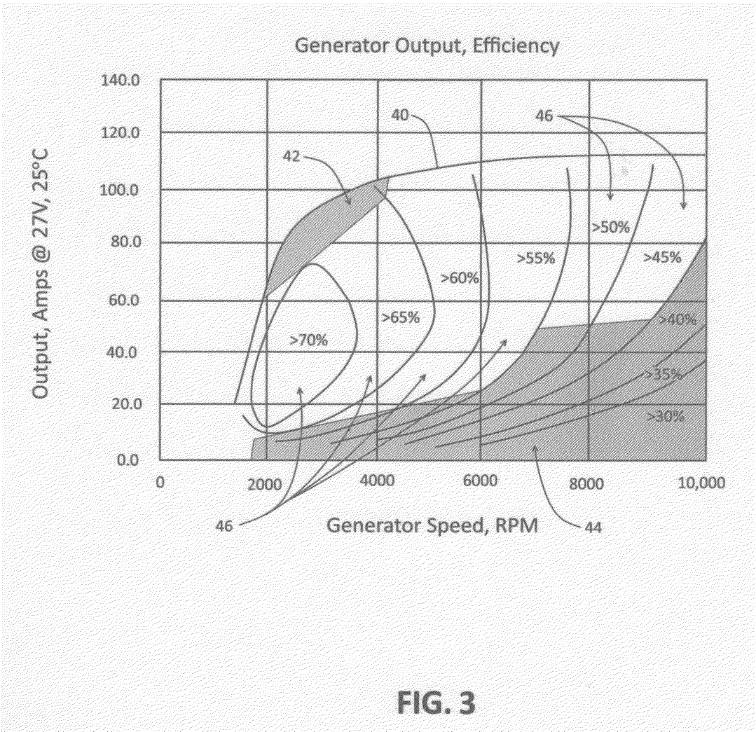

FIG. 3 shows the graph of FIG. 2 with an upper, first region 42 and a lower, second region 44 in which active generator units 24 of a prior parallel generator system would typically operate at electrical loads and engine speeds normally encountered. Notably, regions 42 and 44 are located outside a more efficient target region 46 that includes portions of ranges of higher efficiency. Generally, target region 46 is located between regions 42 and 44.

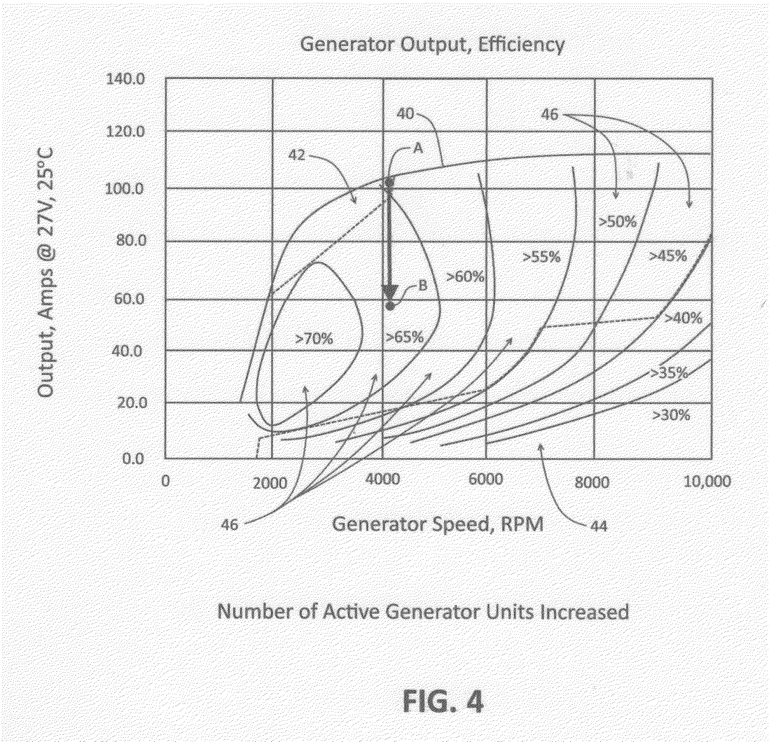

FIGS. 4-6 show the graph of FIG. 3 in which, for purposes of clarity, the boundaries of inefficient regions 42, 44 indicated with dashed lines indicating their borders, with target region 46 located between the dashed line borders. FIGS. 4-6 also respectively show individual examples where parallel generator system efficiency improvements can be realized according to the method of the present disclosure, for different load demand and generator speed conditions. Each respective example is observed at a single generator speed as a number of generator units 24 are selectively activated or deactivated to better utilize them in meeting electrical demand on the system 20. Generally, the relatively inefficient prior system operation in upper, first region 42 is improved by activating one or more additional generator units 24 to push the active generator output downward into target region 46, whereas the relatively inefficient prior system operation in lower, second region 44 is improved by deactivating one or more generator units 24 to push the active generator output upward into target region 46.

The example of FIG. 4 shows a general case of the parallel generator system operation moving from point A in region 42 where a 2.7 kW load is carried by a single active generator unit 24 operating at 60% efficiency, to point B in target region 46 where that load is carried by two active generator units 24 each operating at 65% efficiency, resulting in a 346 W savings from the increase in the number of active generators.

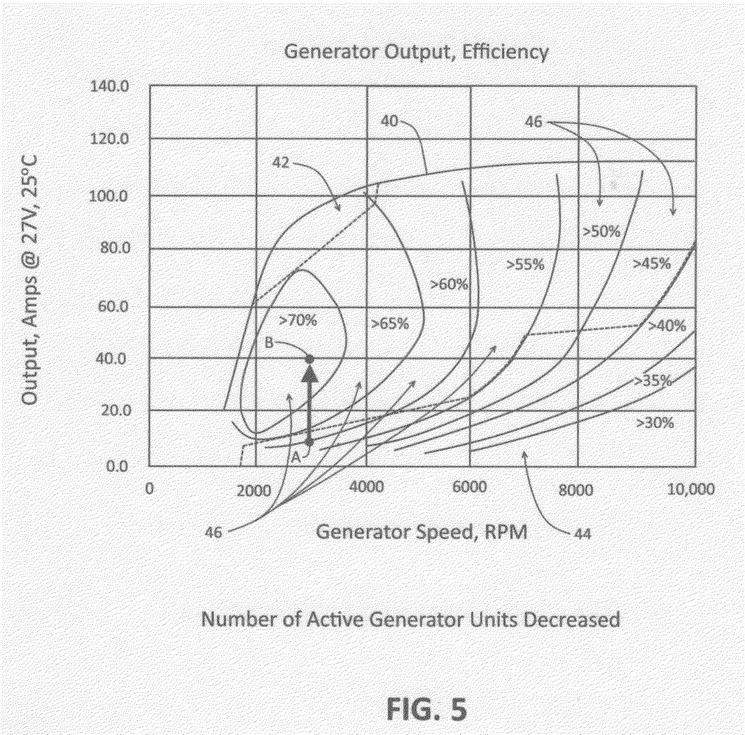

The example of FIG. 5 shows a typical low speed case (e.g., vehicle idling) of the parallel generator system operation moving from point A in region 44 where the load is carried by a four active generator units 24 each operating at 55% efficiency, to point B in target region 46 where that load is carried by a single active generator unit 24 operating at 70% efficiency, resulting in a 421 W savings from the decrease in the number of active generators.

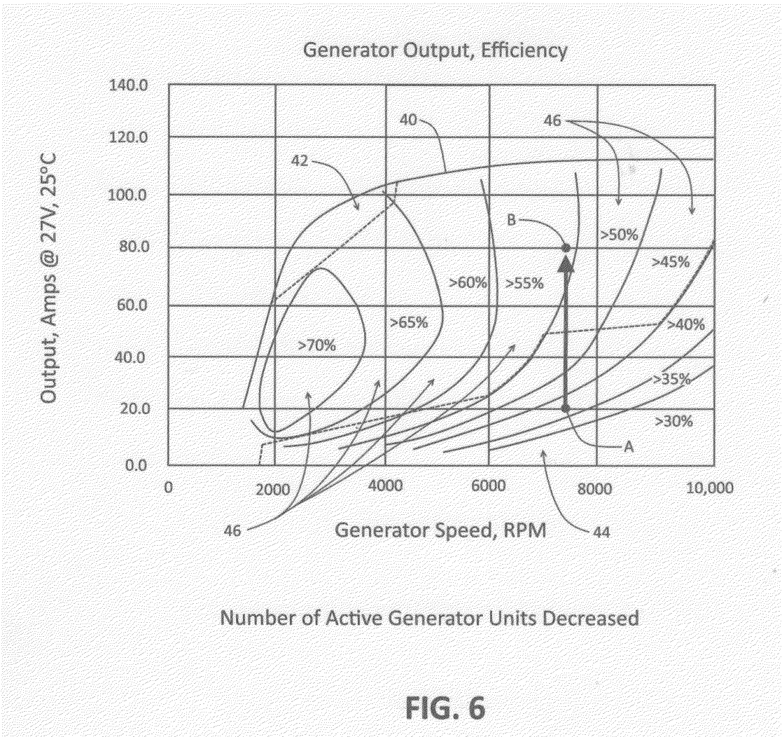

The example of FIG. 6 shows a typical medium speed case (e.g., vehicle cruising speed) of the parallel generator system operation moving from point A in region 44 where a 2.1 kW load is carried by a four active generator units 24 each operating at 40% efficiency, to point B in target region 46 where that load is carried by a single active generator unit 24 operating at 55% efficiency, resulting in a 1473 W savings from the decrease in the number of active generators.

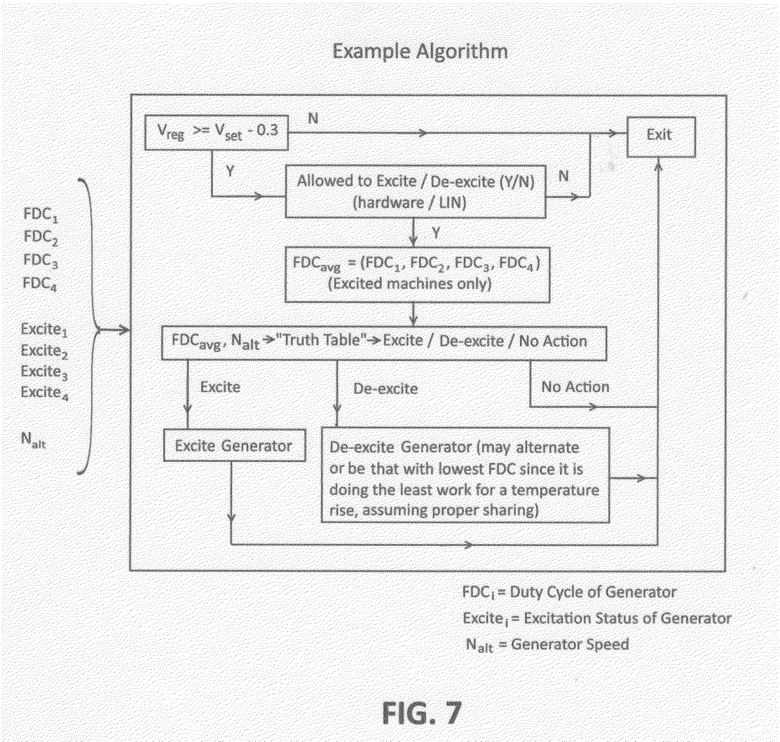

Referring to FIG. 7, an embodiment of the method by which selective activation or deactivation of generator units 24 in system 20 includes using master controller 22 to perform an algorithm that receives as inputs the respective duty cycle, FDC, of each generator unit 24, whether each generator unit is presently active (Excited), and the speed at which the generator is being rotated, Nₐₗₜ. Alternatively, in certain embodiments master controller may be omitted and generator controllers 26 may determine which of the generator units 24 is to be excited or de-excited. Each generator unit's load information is shared via serial communication and compared to optimal generator efficiency points that may be derived from the graph of FIG. 2, which essentially provides a “Truth Table.”

Referring still to FIG. 7, in the presently discussed exemplary embodiment, the generator units 24 are identical alternators all driven at a common speed (Nₐₗₜ) regardless of whether active. Other parameters used in the algorithm include the voltage the system 20 is regulated to provide, V_{reg}, and the voltage setpoint Vₛₑₜ of each respective active generator unit 24. In this example, the four generator units 24 of system 20, designated G1, G2, G3, and G4, respectively have duty cycles designated FDC₁, FDC₂, FDC₃, and FDC₄. In FIG. 7, the algorithm example shows that all four generator units 24 are active (indicated in FIG. 7 as Excite₁, Excite₂, Excite₃, and Excite₄).

The load share algorithm shown in FIG. 7 is applied to each generator unit 24, and starts by determining whether, if that generator's voltage setpoint Vₛₑₜ, is at least 0.3 volts higher than V_{reg}. If not (N), the algorithm exits and proceeds, whereby the next generator unit is subjected to the algorithm; if so (Y), it is determined whether the subject generator unit is allowed to be excited (activated) or de-excited (deactivated). A hardware signal (such as a voltage to a pin on the generator or alternator) or a serial communication signal (such as may be issued over a local interconnect network (LIN)) would first indicate to the generator/alternator whether the generator/alternator is allowed to excite or de-excite itself. This first indication to the generator of whether its self-activation/deactivation is permissible can, for example, prevent the generator's changing from its current activated or deactivated states regardless of the condition being met (Y) that a generator's voltage setpoint Vₛₑₜ is at least 0.3 volts higher than V_{reg}. If, for example, it was desired that generator unit G3 was never to be activated, that instruction would be communicated to system 20 over a LIN or its compliance assured by pulling the above-mentioned pin on the generator/alternator (i.e., the hardware) “low” (to ground). Those of ordinary skill in the art will recognize that, if desired, generator unit G3 of this example could instead be similarly prevented from being deactivated by system 20. Ways are thus provided to override system 20.

Returning to FIG. 7, if the subject generator unit is not allowed to be excited or de-excited (N), the algorithm exits and proceeds; if the subject generator unit is allowed to be excited or de-excited (Y), the average duty cycle FDC_{avg} of only the excited (i.e., active) generator units 24 is then determined. The determination of FDC_{avg} is conducted over a period of, for example, about a minute.

Based on FDC_{avg} and Nₐₗₜ, the algorithm consults the Truth Table (derived from FIG. 2), to determine whether the subject unit 24 should be excited or de-excited, or whether no action should be taken regarding its state of activation. The algorithm is filtered so that there is sufficient hysteresis between activation and deactivation. The inquiry is performed several times, over a period of, for example, one to two minutes, before any action is decided. Once the choice is decided, the activation or deactivation action, or no action, is performed, and the algorithm exits and proceeds. Moreover, the decision of which generator units 24 are to be activated or deactivated can be made on a rotating basis so that no unit is subjected to excessive wear, as discussed above.

At less than full system load, the above strategy divides the load among the correct number of alternators to maximize the system efficiency. This helps to ensure generators do not operate at inefficient low load or maximum load points when possible.

The following is a list of preferred embodiments according to the present disclosure:

1. A parallel generator system, including:
a system bus adapted for connection to an electrical load;
a plurality of generator units connectable in parallel to the system bus, each generator unit activated when providing electrical power to the system bus; and
a plurality of controllers for selective activation and deactivation of at least one generator unit, the controller;
wherein at least one generator unit is selectively activated and deactivated by the controller based on system efficiency level and the number of active generator units, whereby the efficiency of the system subsequent to the selective activation or deactivation of at least one generator unit is increased.
   2. The parallel generator system of embodiment 1, wherein the plurality of generator units is driven at substantially common shaft speed, the electrical output of each active generator unit varying with shaft speed.
   3. A method for using a controller to selectively activate and deactivate generator units based on system efficiency level and the number of generator units, in a parallel generator system.

While exemplary embodiments incorporating the principles of the present invention have been disclosed hereinabove, the present invention is not limited to the disclosed embodiments. Instead, this application is intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A parallel generator system, comprising:
a system bus adapted for connection to an electrical load;
a plurality of generator units connectable in parallel to the system bus, each generator unit activated when providing electrical power to the system bus; and
a plurality of controllers for selective activation and deactivation of at least one generator unit, the controller;
wherein at least one generator unit is selectively activated and deactivated by the controller based on system efficiency level and the number of active generator units, whereby the efficiency of the system subsequent to the selective activation or deactivation of at least one generator unit is increased.

2. The parallel generator system of claim 1, wherein the plurality of generator units is driven at substantially common shaft speed, the electrical output of each active generator unit varying with shaft speed.

3. A method for using a controller to selectively activate and deactivate generator units based on system efficiency level and the number of generator units, in a parallel generator system.
